(19) United States
(12) Patent Application Publication
(10) Pub. No.: US 2019/0061331 A1
(43) Pub. Date: Feb. 28, 2019

(54) PREPARATION OF RETORT PACKAGING INK THROUGH CROSS-LINKING OF POLYURETHANE RESINS

(71) Applicant: BASF SE, Ludwigshafen (DE)

(72) Inventors: Alex BLEVINS, Woodhaven, MI (US); Steven ZIJLSTRA, NA Zwolle (NL); Martin BEK, Sint Nicolaasga (NL)

(21) Appl. No.: 15/766,666

(22) PCT Filed: Oct. 7, 2016
(86) PCT No.: PCT/US2016/055977

§ 371 Date: Apr. 6, 2018

Related U.S. Application Data
(60) Provisional application No. 62/238,934, filed on Oct. 8, 2015.

(51) Int. Cl. B32B 38/00; A23L 3/10; A23L 5/10; B32B 15/04; B32B 1/00; B32B 37/06; B32B 37/18; B65D 75/52; B65D 75/26; B65B 25/00; C09D 11/107; C09D 11/102; C09D 11/037

(52) U.S. Cl. CPC B32B 38/145; B32B 2305/72; A23L 5/10; B32B 15/04; B32B 1/00; B32B 37/06; B32B 37/18; B65D 75/52; B65D 75/26; B65B 25/001; C09D 11/107; C09D 11/102; C09D 11/037; A23V 2002/00; B32B 2250/02; B32B 2255/06; B32B 2255/26; B32B 2307/30; B32B 2307/412; B32B 2307/75; B32B 2439/70; A23L 3/10

(57) ABSTRACT

A method of preparing a retort packaging article includes: providing a sealable packaging; applying an ink to an outer surface of the sealable packaging; and overlaying a substantially transparent lamination layer over the ink and enveloping at least a portion of the sealable packaging. The ink contains a styrene-acrylic resin, which has anhydride functionality, and a polyurethane resin.

### CROSS-REFERENCE TO RELATED APPLICATIONS

The present application claims the benefit of U.S. Provisional Patent Application No. 62/238,934, filed on Oct. 8, 2015, and which is incorporated herein by reference in its entirety.

### FIELD

The present technology is generally related to methods of preparing a retort packaging ink applied to a pouch and/or a laminate, methods of curing an indicia for a retort packaging article by cross-linking the polyurethane resins of the ink, and a retort packaging containing an indicia containing an ink cured by cross-linking polyurethane resins.

### BACKGROUND

Retort packaging is a type of packaging that is constructed from a laminate of flexible plastic and metal foils. It is used for the sterile packaging of a wide variety of food or drink items.

In a solvent-based film to film lamination system, graphics are typically reverse-printed onto one of the films and then are joined to another film using an adhesive. A typical structure often consists of a top film and a bottom film between which are sandwiched a color ink layer, a white ink layer, and an adhesive layer, usually having this order from top to bottom. Graphics are usually printed onto the top film and the bottom film often acts as a sealant. Typical films utilized are polyethylene terephthalate (PET), oriented polypropylene (OPP), oriented polyamide (OPA), or polyethylene (PE) but are not limited to only those as many others such as metallic films can also be used. The adhesives employed are typically two-part 100% solids systems or solvent-borne polyurethane adhesives.

Printed graphics in the retort system typically represent a weak point in the laminate in terms of lamination bond strength as measured by a peel test. The inks used in these types of systems are typically polyurethane binders combined with pigment dispersions prepared in either a polyurethane resin or nitro cellulose. Lamination systems are tested utilizing a color ink with an adhesive, a white ink with an adhesive, and then a color ink backed with a white ink which is then coated with an adhesive. For an ink system to be considered acceptable it must perform well in all three tests. Furthermore, for high performance applications, the ink must maintain high lamination bond strengths after retort conditions. Retort conditions are typically 131° C. for 40 minutes which allows food inside of packaging to either be cooked or the package to be sterilized.

A limitation of current retort packaging and methods of preparation of the packaging is the decreased lamination bond strength after the packaging material undergoes retort conditions. Specifically, typical film to film lamination systems containing elastomeric polyurethane resins show decreased lamination bond strength after the material is subjected to retort conditions.

### SUMMARY

In one aspect, a method is provided for preparing a retort packaging article. The method includes providing a sealable packaging; applying an ink to an outer surface of the sealable packaging; and overlaying a substantially transparent lamination layer over the ink and enveloping at least a portion of the sealable packaging. The ink includes a styrene-acrylic resin, which has anhydride functionality, and a polyurethane resin.

In another aspect, a method is provided for preparing a retort packaging article. The method includes providing a sealable packaging; applying an ink to an inner surface of a substantially transparent lamination layer in a reverse printing orientation to form a printed laminate; and applying the printed laminate to and enveloping at least a portion of the sealable packaging. The ink includes a styrene-acrylic resin, which has anhydride functionality, and a polyurethane resin.

In another aspect, a method is provided for curing an indicia for a retort packaging article. The method includes providing a retort packaging article and heating the retort packaging article to a temperature and for a time period sufficient to ring open at least a portion of the anhydride functionality to cure the ink. The retort packaging article includes: a first substrate in the form of a sealable packaging; a substantially transparent lamination layer overlaying at least a portion of the sealable packaging; and an ink disposed between the substantially transparent lamination layer and the sealable packaging. The ink includes a styrene-acrylic resin having anhydride functionality and a polyurethane resin.

### BRIEF DESCRIPTION OF THE DRAWINGS

FIG. 1 is a gel permeation chromatogram (GPC) of a maleic anhydride resin which was synthesized with one anhydride per chain (solid, thin line) and a typical amine-terminated polyurethane, such as an amine-terminated polyurethane resin (solid, thick line), and the reaction product (dashed line).

FIGS. 2A-2C show Fourier transform infrared (FTIR) spectra of a maleic anhydride resin, which was synthesized with one anhydride per chain (FIG. 2A), an amine-terminated polyurethane resin reacted with the maleic anhydride resin (FIG. 2B), and the difference spectrum (FIG. 2C).

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein may be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

In general, the term “substituted,” unless specifically defined differently, refers to an alkyl, alkenyl, alkynyl, aryl, or ether group, as defined below (e.g., an alkyl group) in which one or more bonds to a hydrogen atom contained therein are replaced by a bond to non-hydrogen or non-carbon atoms. Substituted groups also include groups in which one or more bonds to a carbon(s) or hydrogen(s) atom are replaced by one or more bonds, including double or triple bonds, to a heteroatom. Thus, a substituted group will be substituted with one or more substituents, unless otherwise specified. In some embodiments, a substituted group is substituted with 1, 2, 3, 4, 5, or 6 substituents. Examples of substituent groups include: halogens (i.e., F, Cl, Br, and I); hydroxyls; alkoxy, alkenoxy, alkynoxy, aryloxy, aralkyloxy, heterocyclyloxy, and heterocyclylalkoxy groups; carbonyls (oxo); carboxyls; esters; urethanes; oximes; hydroxylamines; alkoxyamines; aralkoxyamines; thiols; sulfides; sulfoxides; sulfones; sulfonyls; sulfonamides; amines; N-oxides; hydrazines; hydrazides; hydrazones; azides; amides; ureas; amidines; guanidines; enamines; imides; isocyanates; isothiocyanates; cyanates; thiocyanates; imines; nitro groups; nitriles (i.e., CN); and the like. For some groups, substituted may provide for attachment of an alkyl group to another defined group, such as a cycloalkyl group.

Alkyl groups, as used herein, include straight chain and branched alkyl groups having from 1 to 20 carbon atoms, and typically from 1 to 12 carbons or, in some embodiments, from 1 to 8, 1 to 6, or 1 to 4 carbon atoms. Alkyl groups further include cycloalkyl groups having 3 to 8 ring members. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, tert-butyl, neopentyl, isopentyl, and 2,2-dimethylpropyl groups. Cycloalkyl groups, as used herein, are cyclic alkyl groups such as, but not limited to, cyclopropyl, cyclobutyl, cyclopentyl, cyclohexyl, cycloheptyl, and cyclooctyl groups, and also include bridged cycloalkyl groups. Representative substituted alkyl groups can be unsubstituted or substituted.

In some embodiments, the cycloalkyl group has 3 to 8 ring members, whereas in other embodiments the number of ring carbon atoms range from 3 to 5, 3 to 6, or 3 to 7. Cycloalkyl groups further include mono-, bicyclic and polycyclic ring systems, such as, for example bridged cycloalkyl groups as described below, and fused rings, such as, but not limited to, decalinyl, and the like. In some embodiments, polycyclic cycloalkyl groups have three rings. Substituted cycloalkyl groups can be substituted one or more times with, non-hydrogen and non-carbon groups as defined above. However, substituted cycloalkyl groups also include rings that are substituted with straight or branched chain alkyl groups as defined above. Representative substituted cycloalkyl groups can be mono-substituted or substituted more than once, such as, but not limited to, 2,2-, 2,3-, 2,4- 2,5- or 2,6-disubstituted cyclohexyl groups, which can be substituted with substituents such as those listed above. Cycloalkyl groups can also be bridged cycloalkyl groups in which two or more hydrogen atoms are replaced by an alkylene bridge, wherein the bridge can contain 2 to 6 carbon atoms if two hydrogen atoms are located on the same carbon atom, or 1 to 5 carbon atoms, if the two hydrogen atoms are located on adjacent carbon atoms, or 2 to 4 carbon atoms if the two hydrogen atoms are located on carbon atoms separated by 1 or 2 carbon atoms. Bridged cycloalkyl groups can be bicyclic, such as, for example bicyclo[2.1.1]hexane, or tricyclic, such as, for example, adamantyl. Representative bridged cycloalkyl groups include bicyclo[2.1.1]hexyl, bicyclo[2.2.1]heptyl, bicyclo[3.2.1]octyl, bicyclo[2.2.2]octyl, bicyclo[3.2.2]nonyl, bicyclo[3.3.1]nonyl, bicyclo[3.3.2]decanyl, adamantyl, noradamantyl, bornyl, or norbornyl groups. Substituted bridged cycloalkyl groups can be unsubstituted or substituted one or more times with non-hydrogen and non-carbon groups as defined above. Representative substituted bridged cycloalkyl groups can be mono-substituted or substituted more than once, such as, but not limited to, mono-, di- or tri-substituted adamantyl groups, which can be substituted with substituents such as those listed above.

Alkenyl groups, as used herein, include straight and branched chain and cycloalkyl groups as defined above, except that at least one double bond exists between two carbon atoms. Thus, alkenyl groups have from 2 to about 20 carbon atoms, and typically from 2 to 12 carbons or, in some embodiments, from 2 to 8, 2 to 6, or 2 to 4 carbon atoms. In some embodiments, alkenyl groups include cycloalkenyl groups having from 4 to 20 carbon atoms, 5 to 20 carbon atoms, 5 to 10 carbon atoms, or even 5, 6, 7, or 8 carbon atoms. Examples include, but are not limited to vinyl, allyl, —CH═CH(CH₃), —CH═C(CH₃)₂, —C(CH₃)═CH₂, —C(CH₃)═CH(CH₃), CH═CHCH═CH₂, C(CH₂CH₃)═CH₂, cyclohexenyl, cyclopentenyl, cyclohexadienyl, butadienyl, pentadienyl, and hexadienyl, among others. Alkenyl groups may be substituted or unsubstituted. Representative substituted alkenyl groups can be mono-substituted or substituted more than once, such as, but not limited to, mono-, di- or tri-substituted with substituents such as those listed above.

Aryl groups, as used herein, are cyclic aromatic hydrocarbons that do not contain heteroatoms. Aryl groups include monocyclic, bicyclic and polycyclic ring systems. Thus, aryl groups include, but are not limited to, cyclopentadienyl, phenyl, azulenyl, heptalenyl, biphenylenyl, indacenyl, fluorenyl, phenanthrenyl, triphenylenyl, pyrenyl, naphthacenyl, chrysenyl, biphenyl, anthracenyl, indenyl, indanyl, pentalenyl, and naphthyl groups. In some embodiments, aryl groups contain 5-14 carbons, and in others from 5 to 12 or even 6-10 carbon atoms in the ring portions of the groups. Although the phrase “aryl groups” includes groups containing fused rings, such as fused aromatic-aliphatic ring systems (e.g., indanyl, tetrahydronaphthyl, and the like), it does not include aryl groups that have other groups, such as alkyl or halo groups, bonded to one of the ring members. Rather, groups such as tolyl are referred to as substituted aryl groups. Aryl groups may be substituted or unsubstituted. Representative substituted aryl groups can be mono-substituted or substituted more than once. For example, monosubstituted aryl groups include, but are not limited to, 2-, 3-, 4-, 5-, or 6-substituted phenyl or naphthyl groups, which can be substituted with substituents such as those listed above.

Alkoxy groups, as used herein, are hydroxyl groups (—OH) in which the bond to the hydrogen atom is replaced by a bond to a carbon atom of a substituted or unsubstituted alkyl group as defined above. Examples of linear alkoxy groups include but are not limited to methoxy, ethoxy, propoxy, butoxy, pentoxy, hexoxy, and the like. Examples of branched alkoxy groups include but are not limited to isopropoxy, sec-butoxy, tert-butoxy, isopentoxy, isohexoxy, and the like. Examples of cycloalkoxy groups include but are not limited to cyclopropyloxy, cyclobutyloxy, cyclopentyloxy, cyclohexyloxy, and the like. Two subsets of alkoxy groups are “aryloxy” and “arylalkoxy,” as used herein, refer to, respectively, a substituted or unsubstituted aryl group bonded to an oxygen atom and a substituted or unsubstituted aralkyl group bonded to the oxygen atom at the alkyl. Alkoxy groups may be substituted or unsubstituted. Representative substituted alkoxy groups can be substituted one or more times with substituents such as those listed above.

As used herein, the term “acrylates” or “methacrylates” refers to acrylic or methacrylic acid, esters of acrylic or methacrylic acid, and salts, amides, and other suitable derivatives of acrylic or methacrylic acid, and mixtures thereof.

As used herein, the term “acrylic-containing group” or “methacrylate-containing group” refers to a compound that has a polymerizable acrylate or methacrylate group.

As used herein, the term (meth)acrylic or (meth)acrylate refers to acrylic or methacrylic acid, esters of acrylic or methacrylic acid, and salts, amides, and other suitable derivatives of acrylic or methacrylic acid, and mixtures thereof. Illustrative examples of suitable (meth)acrylic monomers include, without limitation, the following methacrylate esters: methyl methacrylate, ethyl methacrylate, n-propyl methacrylate, n-butyl methacrylate (BMA), isopropyl methacrylate, isobutyl methacrylate, n-amyl methacrylate, n-hexyl methacrylate, isoamyl methacrylate, 2-hydroxyethyl methacrylate, 2-hydroxypropyl methacrylate, N,N-dimethylaminoethyl methacrylate, N,N-diethylaminoethyl methacrylate, t-butylaminoethyl methacrylate, 2-sulfoethyl methacrylate, trifluoroethyl methacrylate, glycidyl methacrylate (GMA), benzyl methacrylate, allyl methacrylate, 2-n-butoxyethyl methacrylate, 2-chloroethyl methacrylate, sec-butyl-methacrylate, tert-butyl methacrylate, 2-ethylbutyl methacrylate, cinnamyl methacrylate, crotyl methacrylate, cyclohexyl methacrylate, cyclopentyl methacrylate, 2-ethoxyethyl methacrylate, furfuryl methacrylate, hexafluoroisopropyl methacrylate, methallyl methacrylate, 3-methoxybutyl methacrylate, 2-methoxybutyl methacrylate, 2-nitro-2-methylpropyl methacrylate, n-octylmethacrylate, 2-ethylhexyl methacrylate, 2-phenoxyethyl methacrylate, 2-phenylethyl methacrylate, phenyl methacrylate, propargyl methacrylate, tetrahydrofurfuryl methacrylate and tetrahydropyranyl methacrylate. Example of suitable acrylate esters include, without limitation, methyl acrylate, ethyl acrylate, n-propyl acrylate, isopropyl acrylate, n-butyl acrylate (BA), n-decyl acrylate, isobutyl acrylate, n-amyl acrylate, n-hexyl acrylate, isoamyl acrylate, 2-hydroxyethyl acrylate, 2-hydroxypropyl acrylate, N,N-dimethylaminoethyl acrylate, N,N-diethylaminoethyl acrylate, t-butylaminoethyl acrylate, 2-sulfoethyl acrylate, trifluoroethyl acrylate, glycidyl acrylate, benzyl acrylate, allyl acrylate, 2-n-butoxyethyl acrylate, 2-chloroethyl acrylate, sec-butyl-acrylate, tert-butyl acrylate, 2-ethylbutyl acrylate, cinnamyl acrylate, crotyl acrylate, cyclohexyl acrylate, cyclopentyl acrylate, 2-ethoxyethyl acrylate, furfuryl acrylate, hexafluoroisopropyl acrylate, methallyl acrylate, 3-methoxybutyl acrylate, 2-methoxybutyl acrylate, 2-nitro-2-methylpropyl acrylate, n-octylacrylate, 2-ethylhexyl acrylate, 2-phenoxyethyl acrylate, 2-phenylethyl acrylate, phenyl acrylate, propargyl acrylate, tetrahydrofurfuryl acrylate and tetrahydropyranyl acrylate.

Provided herein are methods of preparing retort packaging having ink applied to a pouch and/or a laminate and methods of curing an indicia for a retort packaging article, all of which includes using an ink containing a styrene-acrylic resin with anhydride functionality and a polyurethane resin. Also provided are retort packaging articles that include an ink containing a styrene-acrylic resin with anhydride functionality and a polyurethane resin.

The use of anhydrides provides a functionality for the cross-linking of polyurethane resin systems used in solvent-based inks, and which imparts improved lamination bond strength. Selection of the anhydride allows for the reaction to either take place at room temperature or at elevated temperatures. In the case of using a styrene-acrylic resin with an anhydride functionality, the cross-linking is heat-activated. Heat activation is considered to be a heat-triggered event. It is possible that other cross-linking chemistries could be introduced which could trigger the cross-linking based on other aspects of the system, such as pH.

Reaction of a polyurethane with an anhydride also allows for new molecules to be generated which would be impossible to achieve via other routes. These new molecules may find use in a variety of applications such as surfactants, dispersants, and compatibilizers.

The retort packaging materials of the present disclosure include a cured ink in which polyurethane resins are cross-linked. The cross-linking of the polyurethane produces a retort packaging material that displays an increased lamination bond strength after being subjected to retort conditions, which allows for higher performance flexible packaging. Furthermore, this type of chemistry opens the possibility for distinctly different chemistries to be combined into one molecule which can act as a surfactant, a compatibilizer, and/or the next generation of pigment dispersant.

In one aspect, a method of preparing a retort packaging article is provided. The method includes providing a sealable packaging; applying an ink to an outer surface of the sealable packaging; and overlaying a substantially transparent lamination layer over the ink and enveloping at least a portion of the sealable packaging. The ink includes a styrene-acrylic resin, which has anhydride functionality, and a polyurethane resin. The retort packaging article may be any retort packing item as known, but in some embodiments it may be a pouch.

The styrene-acrylic resin having anhydride functionality includes the polymerization product of a reaction mixture that contains 15 to 50 wt % of a styrenic monomer; 10 to 35 wt % of a functional monomer; 10 to 30 wt % of an C₁-C₄ alkyl (meth)acrylate; 20 to 55 wt % of an C₅-C₁₂ alkyl (meth)acrylate; and 0 to 20 wt % of a ethylenic monomer. The total wt % of the C₁-C₄ alkyl (meth)acrylate and the C₅-C₁₂ alkyl (meth)acrylate is less than 60 wt % of the total wt % of the styrenic monomer, the functional monomer, the C₁-C₄ alkyl (meth)acrylate, the C₅-C₁₂ alkyl (meth)acrylate, and the ethylenic monomer.

In one embodiment, the styrene-acrylic resin may be a dispersion or an ink that has a low VOC (volatile organic compound) content and a high solids content.

As used herein, low VOC is a relative term referring to a composition having a lower amount of volatile organic components as compared to a conventionally prepared composition. In some embodiments, low VOC compositions have less than or equal to 35% volatile organic content in dispersions, and less or equal to 50% volatile organic content in prepared inks.

The term “styrenic monomers” as used herein refers to aryl vinyl monomers such as styrene, substituted styrenes and ring-substituted styrenes. Exemplary styrenic monomers include styrene, a-methyl styrene, vinyl toluene, a-methylstyrene, o-methylstyrene, m-methylstyrene, p-methylstyrene, t-butyl styrene, vinyl pyridine, ring- α- or β-substituted bromostyrene, o-chlorostyrene, and p-chlorostyrene.

Suitable styrenic monomers for use in the styrene-acrylic resin include those having a substituted or unsubstituted phenyl group attached to an ethylene moiety. Styrenic monomers include, but are not limited to, styrene and a-methylstyrene, and combinations thereof. Other suitable styrenic monomers include, but are not limited to, p-methylstyrene, t-butylstyrene, o-chlorostyrene, vinyl pyridine, and mixtures of these species. In some embodiments, the styrenic monomers include styrene and a-methyl-styrene. The styrenic monomer(s) may be included in the styrene-acrylic resin from about 15 to 50 wt %, based upon the total monomer content of the styrene-acrylic monomer.

According to some embodiments, the styrene-acrylic resin includes a functional monomer. As used herein, a “functional monomer” is a monomer that has functionality that will survive the polymerization process and cause the copolymer to retain such functionality or retain a reaction product of such functionality. For example, functionality may be imparted by polar-protic, polar-aprotic, or non-polar groups on the monomer. Polar-protic groups include, but are not limited to alcohols, primary amines, secondary amines, acids, thiols, sulfates, and phosphates. Polar-aprotic groups include, but are not limited to esters, oxides, ethers, tertiary amines, ketones, aldehydes, carbonates, nitriles, nitros, sulfoxides, and phosphines. Polar-aprotic groups include those imparted to the styrene-acrylic dispersant by (meth)acrylates. Non-polar groups include, but are not limited to, alkyl and aryl groups, including those imparted to the styrene-acrylic dispersant by the monomers of styrene, methyl styrene, 2-ethyl hexyl acrylate, butyl acrylate, octyl acrylate, stearyl acrylate, and behenyl acrylate. For the styrene-acrylic dispersant to remain soluble, the appropriate ratio of non-polar to polar-protic groups must be maintained. Significant levels of polar-protic groups improve solubility. As the amount of non-polar groups increase so should the polar-protic groups. In some embodiments, the functional monomer is a monomer having a carboxylic acid or a hydroxyl group. The functional monomer(s) may be included in the styrene-acrylic resin from about 10 to 35 wt %, based upon the total monomer content of the styrene-acrylic resin.

In one embodiment, the functional monomer is a monomer having a carboxylic acid or hydroxyl functional group.

According to some embodiments, the styrene-acrylic resin is produced by a high-temperature continuous polymerization process. The styrene-acrylic copolymers may be produced using batch, continuous or semi-continuous emulsion polymerizations. The polymerizations may be single or multi-stage polymerizations. For example, continuous polymerization processes are described in U.S. Pat. Nos. 4,546,160; 4,414,370; and 4,529,787, the entire disclosures of which are incorporated herein by reference.

Non-polar or polar-aprotic solubilizing agents, containing pendant, terminal, or main-chain polar-protic or polar-aprotic functionality may also be used to impact the solubility. For example, secondary and tertiary amines containing ethoxylate, propoxylate, alkyl, or alkyl phenol groups; alkyl phenols; fatty alcohols; polypropylene, polyethylene oxides and their copolymers; alkyl amides and esters, may be used in the solvent systems. However, interactions between the polar-protic functionality contained in the dispersant and the solubilizing agent should be minimized to prevent solution instability. Such instability may arise from, for example, salt formation between carboxylic acids functionality and amine solubilizing agents.

Alkyl (meth)acrylate monomers are also used in the styrene-acrylic resins. A mixture of C₁-C₄ alkyl(meth)acrylates and C₅-C₁₂ alkyl(meth)acrylates may be used. C₁-C₄ alkyl(meth)acrylates, include compounds such as methyl (meth)acrylate, ethyl (meth)acrylate, n-propyl (meth)acrylate, iso-propyl (meth)acrylate), n-butyl (meth)acrylate), iso-butyl (meth)acrylate, tert-butyl (meth)acrylate, and any mixtures of any two or more. C₅-C₁₂ alkyl(meth)acrylates, include compounds such as pentyl (meth)acrylate, hexyl (meth)acrylate, heptyl (meth)acrylate, octyl (meth)acrylate, nonyl (meth)acrylate), decyl (meth)acrylate), undeca (meth)acrylate, dodecyl (meth)acrylate, a mixture of any two or more such compounds, and any of the various alkyl isomers thereof. For example, the alkyl isomers of “pentyl” (meth)acrylate include n-pentyl, iso-pentyl, neo-pentyl, sec-pentyl, etc.

The C₁-C₄ alkyl(meth)acrylate monomers may be included in the styrene-acrylic resin from about 10 to 30 wt %, based upon the total monomer content of the styrene-acrylic resin. The C₅-C₁₂ alkyl(meth)acrylate monomers may be included in the styrene-acrylic resin from about 20 to 55 wt %, based upon the total monomer content of the styrene-acrylic resin. However, the total content of the C₁-C₄ alkyl(meth)acrylate monomers and the C₅-C₁₂ alkyl(meth)acrylate monomers is less than about 60 wt % of the total monomer content of the styrene-acrylic resin.

According to some embodiments, the styrene-acrylic resin optionally includes an ethylenic monomer. As used herein, the term “ethylenic monomer” includes monomers containing carbon-carbon double bonds. Examples of ethylenic monomer include, but are not limited to, ethylene, propylene, vinyl chloride, vinyl bromide, vinyl fluoride, maleic anhydride, fumaric acid, acrylonitrile, methacrylontrile, alpha olefins, or mixtures of any two or more such compounds. The ethylenic monomers may be included in the styrene-acrylic resin from zero to about 20 wt %, based upon the total monomer content of the styrene-acrylic resin.

In some embodiments, the ink further includes a colorant or a pigment. In one embodiment, the ink includes an inorganic pigment, an organic pigment, a dye, or a mixture of any two or more such compounds.

Colorants, or pigments, are added to the compositions, according to the various embodiments. In some embodiments, the colorant is an inorganic pigment, an organic pigment, a dye, or a mixture of any two or more such compounds. Other suitable colorants, or pigments, may include, but are not limited to, bright pigments such as aluminum powder, copper powder, nickel powder, stainless steel powder, chromium powder, micaceous iron oxide, titanium dioxide-coated mica powder, iron oxide-coated mica powder, and bright graphite; organic red pigments such as Pink EB, azo- and quinacridone-derived pigments; organic blue pigments such as cyanin blue and cyanin green; organic yellow pigments such as benzimidazolone-, isoindolin- and quinophthalone-derived pigments; inorganic colored pigments such as titanium dioxide (white), titanium yellow, iron red, carbon black, chrome yellow, iron oxide and various calcined pigments. Additionally, extender pigments may be included. Other examples of suitable pigments include, but are not limited to Raven 7000, Raven 5750, Raven 5250, Raven 5000 ULTRAII, Raven 3500, Raven 2000, Raven 1500, Raven 1250, Raven 1200, Raven 1190 ULTRAII, Raven 1170, Raven 1255, Raven 1080 and Raven 1060 (commercially available from Columbian Carbon Co.); Rega1400R, Rega1330R, Rega1660R, Mogul L, Black Pearls L, Monarch 700, Monarch 800, Monarch 880, Monarch 900, Monarch 1000, Monarch 1100, Monarch 1300 and Monarch 1400 (commercially available from Cabot Co.); Color Black FW1, Color Black FW2, Color Black FW2V, Color Black 18, Color Black FW200, Color Black S150, Color Black S160, Color Black S170, Printex35, PrintexU, PrintexV, Printex140U, Printex140V, Special Black 6, Special Black 5, Special Black 4A and Special Black 4 (commercially available from Degussa Co.); No. 25, No. 33, No. 40, No. 47, No. 52, No. 900, No. 2300, MCF-88, MA600, MA7, MA8 and MA100 (commercially available from Mitsubishi Chemical Corporation); cyanic color pigment like C.I. Pigment Blue-1, C.I. Pigment Blue-2, C.I. Pigment Blue-3, C.I. Pigment Blue-15, C.I. Pigment Blue-15:1, C.I. Pigment Blue-15:3, C.I. Pigment Blue-15:34, Pigment Blue 15:4; C.I. Pigment Blue-16, C.I. Pigment Blue-22 and C.I. Pigment Blue-60; magenta color pigment like C.I. Pigment Red-5, C.I. Pigment Red-7, C.I. Pigment Red-12, C.I. Pigment Red-48, C.I. Pigment Red-48:1, C.I. Pigment Red-57, Pigment Red-57:1, C.I. Pigment Red-112, C.I. Pigment Red-122, C.I. Pigment Red-123, C.I. Pigment Red-146, C.I. Pigment Red-168, C.I. Pigment Red-184 and C.I. Pigment Red-202; and yellow color pigment like C.I. Pigment Yellow-1, C.I. Pigment Yellow-2, C.I. Pigment Yellow-3, C.I. Pigment Yellow-12, C.I. Pigment Yellow-13, C.I. Pigment Yellow-14, C.I. Pigment Yellow-16, C.I. Pigment Yellow-17, C.I. Pigment Yellow-73, C.I. Pigment Yellow-74, C.I. Pigment Yellow-75, C.I. Pigment Yellow-83, C.I. Pigment Yellow-93, C.I. Pigment Yellow-95, C.I. Pigment Yellow-97, C.I. Pigment Yellow-98, C.I. Pigment Yellow-114, C.I. Pigment Yellow-128, C.I. Pigment Yellow-129, C.I. Pigment Yellow-151 and C.I. Pigment Yellow-154. Suitable pigments include a wide variety of carbon black, blue, red, yellow, green, violet, and orange pigments.

In another embodiment, the polyurethane resin includes an elastomer produced from polyols reacted with one or more diisocyanates and chain extended with diamines or diols to achieve a molecular weight of about 5000 to about 40,000 Daltons.

In one embodiment, the elastomer includes about 4% to about 40% of hard segments.

In another aspect, a method for preparing a retort packaging article is provided. The method includes providing a sealable packaging; applying an ink to an inner surface of a substantially transparent lamination layer in a reverse printing orientation to form a printed laminate; and applying the printed laminate to and enveloping at least a portion of the sealable packaging. The ink includes a styrene-acrylic resin, which has anhydride functionality, and a polyurethane resin.

In one embodiment, the retort packaging article is a laminate.

In one embodiment, the styrene-acrylic resin is as described herein.

In one embodiment, the styrene-acrylic resin which has anhydride functionality includes the polymerization product of a reaction mixture that contains 15 to 50 wt % of a styrenic monomer; 10 to 35 wt % of a functional monomer; 10 to 30 wt % of an C₁-C₄ alkyl (meth)acrylate; 20 to 55 wt % of an C₅-C₁₂ alkyl (meth)acrylate; and 0 to 20 wt % of a ethylenic monomer. The total wt % of the C₁-C₄ alkyl (meth)acrylate and the C₅-C₁₂ alkyl (meth)acrylate is less than 60 wt % of the total wt % of the styrenic monomer, the functional monomer, the C₁-C₄ alkyl (meth)acrylate, the C₅-C₁₂ alkyl (meth)acrylate, and the ethylenic monomer.

In one embodiment, the styrene-acrylic resin may be a dispersions or an ink that has a low VOC (volatile organic compound) content and a high solids content.

Low VOC is a relative term referring to a composition having a lower amount of volatile organic components as compared to a conventionally prepared composition. In some embodiments, low VOC compositions have less than or equal to 35% volatile organic content in dispersions, and less or equal to 50% volatile organic content in prepared inks.

Styrenic monomers refer to aryl vinyl monomers such as styrene, substituted styrenes and ring-substituted styrenes. Exemplary styrenic monomers include styrene, α-methyl styrene, vinyl toluene, α-methylstyrene, o-methylstyrene, m-methylstyrene, p-methylstyrene, t-butyl styrene, vinyl pyridine, ring- α- or β-substituted bromostyrene, o-chlorostyrene, and p-chlorostyrene.

Suitable styrenic monomers for use in the styrene-acrylic resin include those having a substituted or unsubstituted phenyl group attached to an ethylene moiety. Styrenic monomers include, but are not limited to, styrene and a-methylstyrene, and combinations thereof. Other suitable styrenic monomers include, but are not limited to, p-methylstyrene, t-butylstyrene, o-chlorostyrene, vinyl pyridine, and mixtures of these species. In some embodiments, the styrenic monomers include styrene and a-methyl-styrene. The styrenic monomer(s) may be included in the styrene-acrylic resin from about 15 to 50 wt %, based upon the total monomer content of the styrene-acrylic monomer.

According to some embodiments, the styrene-acrylic resin includes a functional monomer. A “functional monomer” is a monomer that has functionality that will survive the polymerization process and cause the copolymer to retain such functionality or retain a reaction product of such functionality. For example, functionality may be imparted by polar-protic, polar-aprotic, or non-polar groups on the monomer. Polar-protic groups include, but are not limited to alcohols, primary amines, secondary amines, acids, thiols, sulfates, and phosphates. Polar-aprotic groups include, but are not limited to esters, oxides, ethers, tertiary amines, ketones, aldehydes, carbonates, nitriles, nitros, sulfoxides, and phosphines. Polar-aprotic groups include those imparted to the styrene-acrylic dispersant by (meth)acrylates. Non-polar groups include, but are not limited to, alkyl and aryl groups, including those imparted to the styrene-acrylic dispersant by the monomers of styrene, methyl styrene, 2-ethyl hexyl acrylate, butyl acrylate, octyl acrylate, stearyl acrylate, and behenyl acrylate. For the styrene-acrylic dispersant to remain soluble, the appropriate ratio of non-polar to polar-protic groups must be maintained. Significant levels of polar-protic groups improve solubility. As the amount of non-polar groups increase so should the polar-protic groups. In some embodiments, the functional monomer is a monomer having a carboxylic acid or a hydroxyl group. The functional monomer(s) may be included in the styrene-acrylic resin from about 10 to 35 wt %, based upon the total monomer content of the styrene-acrylic resin.

In one embodiment, the functional monomer is a monomer having a carboxylic acid or hydroxyl functional group.

According to some embodiments, the styrene-acrylic resin is produced by a high-temperature continuous polymerization process. The styrene-acrylic copolymers may be produced using batch, continuous or semi-continuous emulsion polymerizations. The polymerizations may be single or multi-stage polymerizations. For example, continuous polymerization processes are described in U.S. Pat. Nos. 4,546,160; 4,414,370; and 4,529,787, the entire disclosures of which are incorporated herein by reference.

Non-polar or polar-aprotic solubilizing agents, containing pendant, terminal, or main-chain polar-protic or polar-aprotic functionality may also be used to impact the solubility. For example, secondary and tertiary amines containing ethoxylate, propoxylate, alkyl, or alkyl phenol groups; alkyl phenols; fatty alcohols; polypropylene, polyethylene oxides and their copolymers; alkyl amides and esters, may be used in the solvent systems. However, interactions between the polar-protic functionality contained in the dispersant and the solubilizing agent should be minimized to prevent solution instability. Such instability may arise from, for example, salt formation between carboxylic acids functionality and amine solubilizing agents.

Alkyl (meth)acrylate monomers are also used in the styrene-acrylic resins. A mixture of C₁-C₄ alkyl(meth)acrylates and C₅-C₁₂ alkyl(meth)acrylates may be used. C₁-C₄ alkyl(meth)acrylates, include compounds such as methyl (meth)acrylate, ethyl (meth)acrylate, n-propyl (meth)acrylate, iso-propyl (meth)acrylate), n-butyl (meth)acrylate), iso-butyl (meth)acrylate, tert-butyl (meth)acrylate, and any mixtures of any two or more. C₅-C₁₂ alkyl(meth)acrylates, include compounds such as pentyl (meth)acrylate, hexyl (meth)acrylate, heptyl (meth)acrylate, octyl (meth)acrylate, nonyl (meth)acrylate), decyl (meth)acrylate), undeca (meth)acrylate, dodecyl (meth)acrylate, a mixture of any two or more such compounds, and any of the various alkyl isomers thereof. For example, the alkyl isomers of “pentyl” (meth)acrylate include n-pentyl, iso-pentyl, neo-pentyl, sec-pentyl, etc.

The C₁-C₄ alkyl(meth)acrylate monomers may be included in the styrene-acrylic resin from about 10 to 30 wt %, based upon the total monomer content of the styrene-acrylic resin. The C₅-C₁₂ alkyl(meth)acrylate monomers may be included in the styrene-acrylic resin from about 20 to 55 wt %, based upon the total monomer content of the styrene-acrylic resin. However, the total content of the C₁-C₄ alkyl(meth)acrylate monomers and the C₅-C₁₂ alkyl(meth)acrylate monomers is less than about 60 wt % of the total monomer content of the styrene-acrylic resin.

According to some embodiments, the styrene-acrylic resin optionally includes an ethylenic monomer. As used herein, the term “ethylenic monomer” includes monomers containing carbon-carbon double bonds. Examples of ethylenic monomer include, but are not limited to, ethylene, propylene, vinyl chloride, vinyl bromide, vinyl fluoride, maleic anhydride, fumaric acid, acrylonitrile, methacrylontrile, alpha olefins, or mixtures of any two or more such compounds. The ethylenic monomers may be included in the styrene-acrylic resin from zero to about 20 wt %, based upon the total monomer content of the styrene-acrylic resin.

In some embodiments, the ink further includes a colorant or a pigment. In one embodiment, the ink includes an inorganic pigment, an organic pigment, a dye, or a mixture of any two or more such compounds.

Colorants, or pigments, are added to the compositions, according to the various embodiments. In some embodiments, the colorant is an inorganic pigment, an organic pigment, a dye, or a mixture of any two or more such compounds. Other suitable colorants, or pigments, may include, but are not limited to, bright pigments such as aluminum powder, copper powder, nickel powder, stainless steel powder, chromium powder, micaceous iron oxide, titanium dioxide-coated mica powder, iron oxide-coated mica powder, and bright graphite; organic red pigments such as Pink EB, azo- and quinacridone-derived pigments; organic blue pigments such as cyanin blue and cyanin green; organic yellow pigments such as benzimidazolone-, isoindolin- and quinophthalone-derived pigments; inorganic colored pigments such as titanium dioxide (white), titanium yellow, iron red, carbon black, chrome yellow, iron oxide and various calcined pigments. Additionally, extender pigments may be included. Other examples of suitable pigments include, but are not limited to Raven 7000, Raven 5750, Raven 5250, Raven 5000 ULTRAII, Raven 3500, Raven 2000, Raven 1500, Raven 1250, Raven 1200, Raven 1190 ULTRAII, Raven 1170, Raven 1255, Raven 1080 and Raven 1060 (commercially available from Columbian Carbon Co.); Rega1400R, Rega1330R, Rega1660R, Mogul L, Black Pearls L, Monarch 700, Monarch 800, Monarch 880, Monarch 900, Monarch 1000, Monarch 1100, Monarch 1300 and Monarch 1400 (commercially available from Cabot Co.); Color Black FW1, Color Black FW2, Color Black FW2V, Color Black 18, Color Black FW200, Color Black S150, Color Black S160, Color Black S170, Printex35, PrintexU, PrintexV, Printex140U, Printex140V, Special Black 6, Special Black 5, Special Black 4A and Special Black 4 (commercially available from Degussa Co.); No. 25, No. 33, No. 40, No. 47, No. 52, No. 900, No. 2300, MCF-88, MA600, MA7, MA8 and MA100 (commercially available from Mitsubishi Chemical Corporation); cyanic color pigment like C.I. Pigment Blue-1, C.I. Pigment Blue-2, C.I. Pigment Blue-3, C.I. Pigment Blue-15, C.I. Pigment Blue-15:1, C.I. Pigment Blue-15:3, C.I. Pigment Blue-15:34, Pigment Blue 15:4; C.I. Pigment Blue-16, C.I. Pigment Blue-22 and C.I. Pigment Blue-60; magenta color pigment like C.I. Pigment Red-5, C.I. Pigment Red-7, C.I. Pigment Red-12, C.I. Pigment Red-48, C.I. Pigment Red-48:1, C.I. Pigment Red-57, Pigment Red-57:1, C.I. Pigment Red-112, C.I. Pigment Red-122, C.I. Pigment Red-123, C.I. Pigment Red-146, C.I. Pigment Red-168, C.I. Pigment Red-184 and C.I. Pigment Red-202; and yellow color pigment like C.I. Pigment Yellow-1, C.I. Pigment Yellow-2, C.I. Pigment Yellow-3, C.I. Pigment Yellow-12, C.I. Pigment Yellow-13, C.I. Pigment Yellow-14, C.I. Pigment Yellow-16, C.I. Pigment Yellow-17, C.I. Pigment Yellow-73, C.I. Pigment Yellow-74, C.I. Pigment Yellow-75, C.I. Pigment Yellow-83, C.I. Pigment Yellow-93, C.I. Pigment Yellow-95, C.I. Pigment Yellow-97, C.I. Pigment Yellow-98, C.I. Pigment Yellow-114, C.I. Pigment Yellow-128, C.I. Pigment Yellow-129, C.I. Pigment Yellow-151 and C.I. Pigment Yellow-154. Suitable pigments include a wide variety of carbon black, blue, red, yellow, green, violet, and orange pigments.

In another embodiment, the polyurethane resin is as described herein. In one embodiment, the polyurethane resin includes an elastomer produced from polyols reacted with one or more diisocyanates and chain extended with diamines or diols to achieve a molecular weight of about 5000 to about 40,000 Daltons.

In one embodiment, the elastomer includes about 4% to about 40% of hard segments.

In a further aspect, provided herein is a method for curing an indicia for a retort packaging article. The method includes: providing a retort packaging article comprising and heating the retort packaging article to a temperature and for a time period sufficient to ring open at least a portion of the anhydride functionality to cure the ink.

The retort packaging article includes a first substrate in the form of a sealable packaging; a substantially transparent lamination layer overlaying at least a portion of the sealable packaging; and an ink disposed between the substantially transparent lamination layer and the sealable packaging. The ink includes a styrene-acrylic resin having anhydride functionality and a polyurethane resin.

In one embodiment, the outer surface of the printable substrate contains hydroxyl groups or carboxylic acids. In another embodiment, the surface lamination layer which contacts the ink contains hydroxyl groups or carboxylic acids.

In some embodiments, the retort packaging article exhibits a lamination bond strength of greater than 3 N/15 mm after heating. In one embodiment, the lamination bond strength is about 3.9 N/15 mm after heating.

In some embodiments, the retort packaging article exhibits a higher lamination bond strength after heating as compared to the lamination bond strength of the ink before heating.

In some embodiments, the method further includes sealing a payload within the retort packaging article prior to heating. In one embodiment, the payload is a food article. In one embodiment, the temperature and time period are sufficient to sterilize or cook the food article.

In one embodiment, the temperature is about 100° C. or greater. In another embodiment, the temperature is from about 100° C. to about 150° C. In yet another embodiment, the temperature is about 130° C.

In yet a further aspect, provided herein is a retort packaging that includes: a sealable foil-based packaging substrate having an inner and outer surface; a laminate overlay having an inner face and an outer face, the inner face being proximal to the sealable foil-based packaging substrate; and an indicia disposed between the sealable foil-based packaging substrate and the laminate overlay, wherein the retort packaging has been subjected to a temperature of 100° C. or greater for a time period sufficient to cure the ink via ring-opening of the anhydride functionality. The indicia includes an ink that contains a styrene-acrylic resin having anhydride functionality and a polyurethane resin.

A resin blend of the styrene-acrylic resin and the polyurethane resin of the methods disclosed herein can also be used in other applications, besides retort packaging. The resin blend of the styrene-acrylic resin and the polyurethane resin can be used as, but is not limited to, a dispersant, a surfactant, and/or a compatibilizer.

To disperse pigment, the main objective of the resin of a dispersant is to prevent the agglomeration of the pigment particles after grinding to near primary particle size. The stabilization of the pigment particles can be achieved by a combination of steric and electronic stabilization. This topic has been studied and presented in patents and open literature at length. An acrylic polyurethane hybrid allows for the acrylic portion to be designed to associate with pigments and the polyurethane to be designed to be compatible with resins used in solvent based printing. It is well known that the inclusion of acid groups in an acrylic resin allows for excellent pigment dispersion but the inclusion of acid functionality in a polyurethane which is extended with an amine is limited. Therefore, coupling the polyurethane to an acrylic solves this problem.

Surfactants have a hydrophobic tail with a hydrophilic head group which promotes assembly into micelles when dispersed into water. In the micelle, the hydrophilic head group is at the water interface while the hydrophobic tails self-associate to produce a hydrophobic cone of the micelle. This arrangement can be accomplished by coupling a hydrophilic acrylic resin to a hydrophobic polyurethane. In this type of structure the polyurethane groups should arrange to form micelles with the acrylic resin to be at the water interface while the polyurethane self-associates. This type of a molecule could bring components into the water phase which are normally not soluble.

A similar concept as that of a surfactant is the generation of a compatibilizer which could potentially make dissimilar polymers soluble in each other.

The present embodiments, thus generally described, will be understood more readily by reference to the following examples, which are provided by way of illustration and are not intended to be limiting of the present technology in any way.

### EXAMPLES

### Example 1

A standard polyurethane, such as an amine-terminated polyurethane resin, was used to generate a solvent-borne ink for comparison to an ink generated by blending an acid and anhydride containing acrylic resin with the same polyurethane in a 1:1 concentration. In Table 1 it can be seen that typical polyurethane lamination bond strength is on the order of 3 N/15 mm for color ink laminate before retort and increases to 4 N/15 mm after retort. In a white ink lamination the same polyurethane is seen to give much lower lamination bond strength of only 1.4 N/15mm before retort and 1.2 N/15 mm after. When the acrylic resin is blended with the polyurethane it can be seen that color ink laminate is about the same in terms of lamination bond strength but the performance of the white ink laminate is much improved. The white ink containing the anhydride acrylic resin can be seen to go from 2.7 N/15mm up to 4.5 N/15mm, this improvement can also be observed in the color ink backed with white ink combination as well going from 3.7 to 6.5 N/15mm.

TABLE 1
Lamination Bond Strengths Before and
After Retort of Laminated Systems

| | 100% Color | | Color/White | | 100% White | |
|---|---|---|---|---|---|---|
| | Prior to | After | Prior to | After | Prior to | After |
| | Retort | Retort | Retort | Retort | Retort | Retort |
| Amine- | 3.4 | 4.1 | 3.6 | 4.0 | 1.4 | 1.2 |
| terminated | | | | | | |
| polyurethane | | | | | | |
| resin | | | | | | |
| Amine- | 3.2 | 4.98 | 3.7 | 6.5 | 2.7 | 4.5 |
| terminated | | | | | | |
| polyurethane | | | | | | |
| resin/ | | | | | | |
| Styrene- | | | | | | |
| acrylic resin | | | | | | |
| with an | | | | | | |
| anhydride | | | | | | |
| functionality | | | | | | |

### Example 2

A second ink was generated using a different pigment than that used in Example 1. The second ink was then compared to the amine-terminated polyurethane resin/styrene-acrylic resin with an anhydride functionality blended system and to the pure amine-terminated polyurethane resin. However, in this test two additional acrylic resins which contain an acid functionality were also included as was a sample of an amine-terminated polyurethane resinwith a styrene-acrylic resin with an anhydride functionality, which had been heated before making the ink. It can be seen in Table 2 that the lamination bond strength increases only in the case of the styrene-acrylic resin with an anhydride functionality blended system after retort conditions are achieved. It can be seen that the sample of the amine-terminated polyurethane resin/styrene-acrylic resin with an anhydride functionality heated actually showed lamination bond strengths in the same magnitude of the amine-terminated polyurethane resinbut gave values that decrease after retort. In addition to this marked improvement on lamination bond strength of the blended system, there was also an improvement in the flow characteristics of the dispersions and inks when using the acrylic resin as can be seen in Table 3. The evaluation of flow of the inks ranges from 0 to 5 where 5 is the best. It can be seen that the mixture product is not a perfect 5 but it does outperform the standard polyurethane in flow.

TABLE 2
Lamination Bond Strengths Before and
after Retort of Laminated Systems

| | Prior to Retort | After Retort |
|---|---|---|
| Amine-terminated | 1.4 | 1.3 |
| polyurethane resin | | |
| Amine-terminated | 3.1 | 3.9 |
| polyurethane resin/Styrene- | | |
| acrylic resin with an | | |
| anhydride functionality | | |
| Amine-terminated | 2.0 | 1.4 |
| polyurethane resin/J678 | | |
| Amine-terminated | 1.0 | 0.5 |
| polyurethane resin/B81 | | |
| Amine-terminated | 1.2 | 0.9 |
| polyurethane resin/Styrene- | | |
| acrylic resin with anhydride | | |
| functionality Heated | | |

TABLE 3
Flow and Appearance of Inks

| | Irgalith | | Carmine | | Cinquasia | |
|---|---|---|---|---|---|---|
| | GLVO | | FBB02-CN | | Violet L5120 | |
| | | Trans- | | Trans- | | Trans- |
| Resin | Flow | parency | Flow | parency | Flow | parency |
| Amine- | 5 | 5 | 3 | 4 | 2 | 3 |
| terminated | | | | | | |
| polyurethane | | | | | | |
| resin | | | | | | |
| Amine- | 5 | 5 | 3 | 5 | 4 | 4 |
| terminated | | | | | | |
| polyurethane | | | | | | |
| resin/ | | | | | | |
| Styrene- | | | | | | |
| acrylic resin | | | | | | |
| with | | | | | | |
| anhydride | | | | | | |
| functionality | | | | | | |

### Example 3

It is believed that the improvement of lamination bond strength is due to the chemical reaction of the amine terminal groups of the polyurethane with the anhydrides of the acrylic resin. This belief is substantiated by results from blending another acrylic resin which does not contain anhydrides, Joncryl® 678, which is a solid grade oligomer resin composed of roughly ⅓ styrene, ⅓ acrylic acid, and ⅓ alpha-methylstyrene, with the same polyurethane which showed no improvement in bond strength. The reaction of amines with anhydrides is well established in the literature but there is no reference of a polyurethane terminated in an amine reacted with an anhydride, or used for this application.

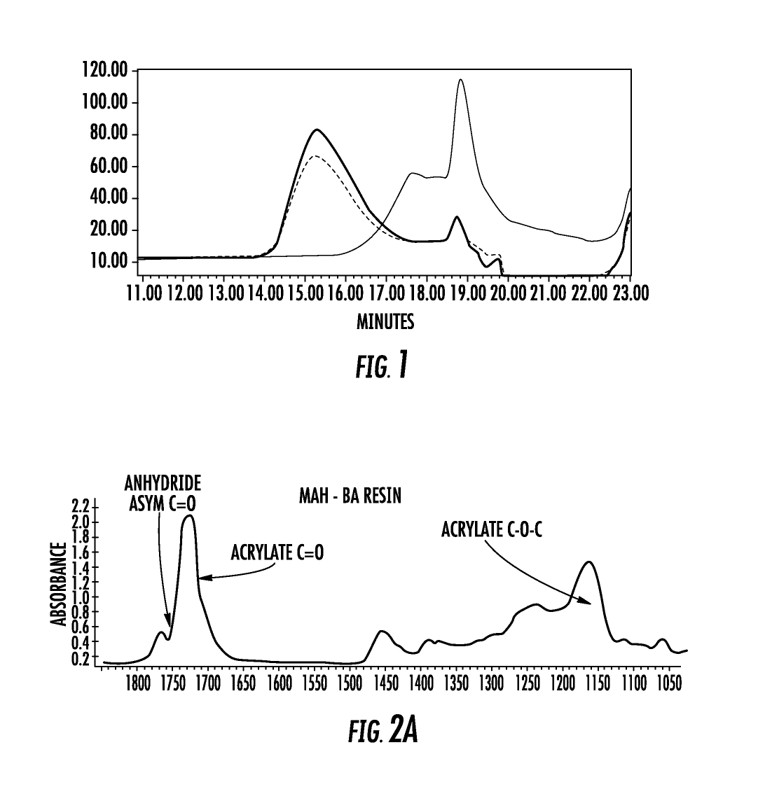

The anhydride can be accessed by reacting either an isocyanate or an amine with an anhydride-containing acrylic resin. The reaction of an isocyanate with the anhydride has been shown in the literature, which results in an imide and the formation of CO₂. The reaction of the amine group on a polyurethane results in the half acid and an amide but no gas is evolved. To demonstrate the reactions, a model compound was synthesized in the SGO which generated a polymer with on average one maleic anhydride (MAH) per chain and the remaining monomer was non-reactive with the polyurethane used. The model MAH polymer was then used to demonstrate that the described reactions go to completion by evaluating the reaction product of each of these via GPC and observed the disappearance the MAH resin's discrete peak (see FIG. 1). FIG. 1 shows the GPC traces of a MAH resin which was synthesized with one anhydride per chain (solid, thin line), a typical amine terminated polyurethane (solid, thick line), and then the reaction product (dashed line). It can be seen that the peak for the anhydride resin is absent in the product.

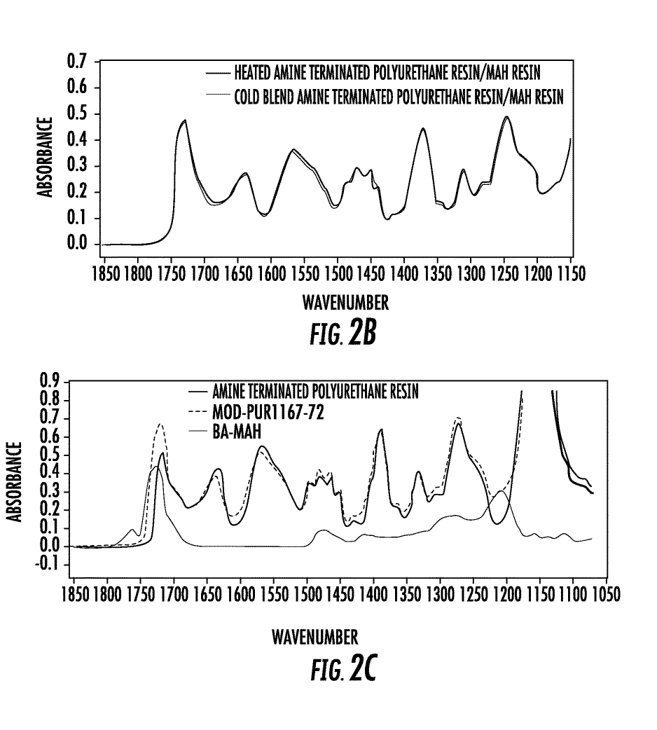

To support this finding titration was conducted on the polyurethane before and after reaction with the MAH resin, the amine value fell from 12.5 to 9.5 indicating that amines had been consumed while forming the amide. Further investigation of the system via FT-IR showed that the signal for the anhydride peak disappeared in the final product as can be seen in FIG. 2. FIG. 2A shows the trace of the MAH resin. FIG. 2B shows the trace of the polyurethane reacted with the MAH resin. FIG. 2C shows the difference spectrum between the MAH resin and the polyurethane reacted with the MAH resin. The forming of amide bonds was not observed in the FT-IR but this is not atypical when the bond in question is at a low concentration and the product also contains a high concentration of urea.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

1. A method for preparing a retort packaging article, the method comprising:
(A) providing a sealable packaging;
applying an ink to an outer surface of the sealable packaging; and
overlaying a substantially transparent lamination layer over the ink and enveloping at least a portion of the sealable packaging; or
(B) providing a sealable packaging;
applying an ink to an inner surface of a substantially transparent lamination layer in a reverse printing orientation to form a printed laminate; and
applying the printed laminate to and enveloping at least a portion of the sealable packaging;
wherein:
the ink comprises a styrene-acrylic resin having anhydride functionality, and a polyurethane resin.

2. The method of claim 1, wherein the styrene-acrylic resin having anhydride functionality comprises the polymerization product of a reaction mixture comprising:
15 to 50 wt % of a styrenic monomer;
10 to 35 wt % of a functional monomer;
10 to 30 wt % of an C₁-C₄ alkyl (meth)acrylate;
20 to 55 wt % of an C₅-C₁₂ alkyl (meth)acrylate; and
0 to 20 wt % of a ethylenic monomer;
wherein the total wt % of the C₁-C₄ alkyl (meth)acrylate and the C₅-C₁₂ alkyl (meth)acrylate is less than 60 wt % of the total wt % of the styrenic monomer, the functional monomer, the C₁-C₄ alkyl (meth)acrylate, the C₅-C₁₂ alkyl (meth)acrylate, and the ethylenic monomer.

3. The method of claim 2, wherein the functional monomer is a monomer having a carboxylic acid or hydroxyl functional group.

4. The method of claim 1, wherein the ink further comprises an inorganic pigment, an organic pigment, a dye, or a mixture of any two or more thereof.

5. The method of claim 1, wherein the polyurethane resin comprises an elastomer produced from polyols reacted with one or more diisocyanates and chain extended with diamines or diols to achieve a molecular weight of about 5000 to about 40,000 Daltons.

6. The method of claim 5, wherein the elastomer comprises about 4% to about 40% of hard segments.

7-12. (canceled)

13. A method for curing an indicia for a retort packaging article, the method comprising:
providing a retort packaging article comprising:
a first substrate in the form of a sealable packaging;
a substantially transparent lamination layer overlaying at least a portion of the sealable packaging;
an ink disposed between the substantially transparent lamination layer and the sealable packaging, wherein the ink comprises a styrene-acrylic resin having anhydride functionality and a polyurethane resin; and
heating the retort packaging article to a temperature and for a time period sufficient to ring open at least a portion of the anhydride functionality to cure the ink.

14. The method of claim 13, wherein the outer surface of the printable substrate comprises hydroxyl groups or carboxylic acids.

15. The method of claim 13, wherein the surface lamination layer which contacts the ink comprises hydroxyl groups or carboxylic acids.

16. The method of claim 13, wherein the retort packaging article exhibits a lamination bond strength of greater than 3 N/15 mm after heating.

17. The method of claim 16, wherein the lamination bond strength is about 3.9 N/15 mm after heating.

18. The method of claim 13, wherein the retort packaging article exhibits a higher lamination bond strength after heating as compared to the lamination bond strength of the ink before heating.

19. The method of claim 13 further comprising sealing a payload within the retort packaging article prior to heating.

20. The method of claim 19, wherein the payload is a food article.

21. The method of claim 20, wherein the temperature and time period are sufficient to sterilize or cook the food article.

22. The method of claim 13, wherein the temperature is about 100° C. or greater.

23. The method of claim 22, wherein the temperature is from about 100° C. to about 150° C.

24. The method of claim 23, wherein the temperature is about 130° C.

25. A retort packaging comprising:
a sealable foil-based packaging substrate having an inner and outer surface;
a laminate overlay having an inner face and an outer face, the inner face being proximal to the sealable foil-based packaging substrate; and
an indicia disposed between the sealable foil-based packaging substrate and the laminate overlay, the indicia comprising an ink comprising a styrene-acrylic resin having anhydride functionality and a polyurethane resin; and
wherein:
the retort packaging has been subjected to a temperature of 100° C. or greater for a time period sufficient to cure the ink via ring-opening of the anhydride functionality.
